(19) United States
(12) Patent Application Publication
(10) Pub. No.: US 2026/0149007 A1
(43) Pub. Date: May 28, 2026

(54) PRIMARY LITHIUM BATTERY

(71) Applicant: EVE ENERGY CO.,LTD., Guangdong (CN)

(72) Inventors: Qianqian YAN, Guangdong (CN); Xinjie Zhang, Guangdong (CN); Xinbin Qiu, Guangdong (CN); Ruirui Zhao, Guangdong (CN)

(21) Appl. No.: 19/078,996

(22) Filed: Mar. 13, 2025

Related U.S. Application Data
(63) Continuation of application No. PCT/CN2024/144229, filed on Dec. 31, 2024.

(30) Foreign Application Priority Data
Nov. 22, 2024 (CN) 202422873865.0

(51) Int. Cl. H01M 6/16; H01M 4/06; H01M 4/62; H01M 50/431; H01M 50/489

(52) U.S. Cl. CPC H01M 6/16; H01M 4/06; H01M 4/62; H01M 50/431; H01M 50/489

(57) ABSTRACT

A primary lithium battery includes a positive electrode, a negative electrode, a separator arranged between the positive electrode and the negative electrode, and a non-aqueous electrolyte is provided. A modified layer is arranged on at least one side of the positive electrode facing the negative electrode and/or the modified layer is arranged on at least one side of the separator. The modified layer includes a substrate layer and a carbon layer which is arranged on one side of the substrate layer. The modified layer has a specific structure arranged between the positive electrode and the negative electrode, thereby further improving the pulse performance at high temperature of the primary lithium battery and reducing the internal resistance of the battery.

### CROSS-REFERENCE TO RELATED APPLICATION

This application is a continuation of International Application No. PCT/CN2024/144229, which claims priority to Chinese Patent Application No. 2024228738650, filed in China National Intellectual Property Administration on Nov. 22, 2024, the disclosures of which are incorporated herein by reference in their entireties.

### TECHNICAL FIELD

The present application relates to the technical field of batteries, and specifically to a primary lithium battery.

### BACKGROUND

Primary lithium batteries are widely used in fields such as portable electronic equipment or medical devices due to the advantages of high energy density, wide operating temperature range, long storage life, and strong environmental adaptability. With the increasing demand for functionalization and lightweight of electronic devices, the market demands for higher output capacity from the primary lithium batteries.

Components of a primary lithium battery comprise: a positive electrode (comprising metal oxide such as manganese dioxide, graphite fluoride, iron sulfide, or thionyl chloride-type positive active substances), a negative electrode of lithium metal or lithium alloy, a separator and a non-aqueous electrolyte.

In one aspect, in the primary lithium battery, the negative electrode material is generally metal lithium or a lithium alloy, and the active lithium contained therein is prone to side reactions with certain components in the non-aqueous electrolyte to generate gases or form a coating of high-resistance (or insulating) components on the surface of the negative electrode. Therefore, the electrochemical reaction of the primary lithium battery may be damaged or the internal resistance of the battery may increase accordingly, resulting in a deterioration of the discharge performance of the primary lithium battery.

In another aspect, in the primary lithium battery system where manganese dioxide or graphite fluoride is used as a positive active material, a portion of the positive active material is dissolved in the non-aqueous electrolyte, thereby generating manganese ions or fluoride ions, and the released ions may migrate to the negative electrode side and react with the negative electrode material to form a high-resistance or insulating coating, thereby increasing the internal resistance of the primary lithium battery and affecting the electrochemical performance of the primary lithium battery.

In addition, when manganese dioxide or fluoride graphite is used as a positive active substance in the practice, with the increase of the depth of discharge, the dissolution amount of manganese ions or fluoride ions is gradually increasing. If the primary lithium battery is stored at high temperature after certain degree of discharge, the surface of the negative electrode is prone to generating a large amount of the high-resistance component, resulting in a significant increase in the resistance of the negative electrode and the primary lithium battery. In view of the above, when the primary lithium battery is reused after stored at high temperature, the primary lithium battery still remains some power, but its discharge characteristics are significantly reduced, especially, the high-current discharge characteristics and pulse discharge characteristics at high temperature are greatly reduced, and the high-current discharge cannot be performed.

Therefore, in this field, it is urgent to develop a primary lithium battery to solve the above deficiencies.

### SUMMARY

The present application provides a primary lithium battery which includes a modified layer having a specific structure arranged between a positive electrode and a negative electrode, thereby further improving the pulse performance at high temperature of the primary lithium battery and reducing the internal resistance of the battery.

The present application provides a primary lithium battery including a positive electrode, a negative electrode, a separator arranged between the positive electrode and the negative electrode, and a non-aqueous electrolyte; a modified layer is arranged on at least one side of the positive electrode facing the negative electrode and/or the modified layer is arranged on at least one side of the separator; wherein the modified layer comprises a substrate layer and a carbon layer which is arranged on one side of the substrate layer.

Compared to the related art, the present application has the following beneficial effects.

The present application provides a primary lithium battery. By arranging a modified layer on at least one side of the positive electrode and/or the separator, the surface of the negative electrode is protected from the positive active substance of manganese dioxide or graphite fluoride, and ultimately, the dissolved manganese ions or fluoride ions are prevented from reacting with the negative electrode to form a high-resistance coating, thereby reducing the internal resistance of the primary lithium battery and enhancing the pulse performance of the primary lithium battery, which, more importantly, not only solves the technical problem that the internal resistance of primary lithium battery may increase due to the migration of dissolved ions from the positive electrode material to the negative electrode side when the batteries are stored after the partial discharge, but also solves the technical problem that the primary lithium battery have poor pulse discharge performance under the high-temperature application environment.

Other aspects can be understood after the accompanying drawings and detailed description are read and understood.

### BRIEF DESCRIPTION OF THE DRAWINGS

FIG. 1 shows a structural schematic diagram of a primary lithium battery provided in the present application;

FIG. 2 shows a schematic diagram of a modified layer arranging on the surface of a separator provided in the present application;

FIG. 3 shows a structural schematic diagram of a modified layer arranging on the surface of a positive electrode and a separator and a schematic diagram of detail A provided in the present application;

FIG. 4 shows a structural schematic diagram of a modified layer arranging on the surface of a positive electrode and a schematic diagram of detail B provided in the present application;

FIG. 5 shows a schematic diagram of a modified layer arranging on the surface of a positive electrode provided in the present application;

FIG. 6 shows a pulse performance graph of primary lithium batteries provided in Examples 1-6 and Comparative Example 1 at 45° C. in the present application.

Reference list: 1—positive electrode pole, 2—cover plate, 3—glass seal, 4—positive mesh collector, 5—negative electrode, 6—separator, 7—positive electrode, 8—modified layer, 81—first modified layer, 82—second modified layer, 9—negative mesh collector, 10—bottom film, and 11—liquid injection port.

### DETAILED DESCRIPTION

The present application provides a primary lithium battery including a positive electrode, a negative electrode, a separator arranged between the positive electrode and the negative electrode, and a non-aqueous electrolyte; a modified layer is arranged on at least one side of the positive electrode facing the negative electrode and/or the modified layer is arranged on at least one side of the separator; wherein the modified layer comprises a substrate layer and a carbon layer which is arranged on one side of the substrate layer.

In the present application, by arranging a modified layer on at least one side of the positive electrode and/or the separator, the surface of the negative electrode is protected from the positive active substance of manganese dioxide or graphite fluoride, and ultimately, the dissolved manganese ions or fluoride ions are prevented from reacting with the negative electrode to form a high-resistance coating, thereby reducing the internal resistance of the primary lithium battery and enhancing the pulse performance of the primary lithium battery, which, more importantly, not only solves the technical problem that the internal resistance of primary lithium battery may increase due to the migration of dissolved ions from the positive electrode material to the negative electrode side when the batteries are stored after the partial discharge, but also solves the technical problem that the primary lithium battery have poor pulse discharge performance under the high-temperature application environment.

As an optional technical solution of the present application, the modified layer is arranged on two sides of the positive electrode facing the negative electrode and/or the modified layer is arranged on two sides of the separator.

As an optional technical solution of the present application, in a case where the modified layer is arranged on at least one side of the positive electrode, the substrate layer is in contact with at least one surface of the positive electrode, and the carbon layer is arranged on a side of the positive electrode facing the separator.

As an optional technical solution of the present application, in a case where the modified layer is arranged on at least one side of the separator, the substrate layer is in contact with at least one surface of the separator, and the carbon layer is arranged on a side of the separator facing the positive electrode and/or on a side of the separator facing the negative electrode.

In the present application, a slurry of the carbon layer comprises a carbon material, a binder, a thickener, and a dispersant. A person skilled in the art may adjust the proportion of each component according to the actual situation, which is not limited herein.

In the present application, the carbon material exemplarily comprises any one or a combination of at least two of graphite (e.g., natural graphite, or artificial graphite, etc.), carbon black (e.g., acetylene black, Ketjen black, channel black, furnace black, blocky carbon black, or thermal black, etc.), carbon fibers, or carbon nanotubes.

In the present application, the binder, the thickener, and the dispersant are conventional commercially available reagents in the field, which are not limited in the present application.

In the present application, the dispersant is not particularly limited as long as it does not react with the carbon material. However, a substance with a high volatility or a low boiling point can be selected for easy removal.

As an optional technical solution of the present application, a length of the carbon layer is 5-45 mm, which may be, for example, 5 mm, 8 mm, 10 mm, 12 mm, 15 mm, 18 mm, 20 mm, 22 mm, 25 mm, 28 mm, 30 mm, 32 mm, 35 mm, 38 mm, 40 mm, 42 mm, or 45 mm, etc.; a width of the carbon layer is 2-35 mm, which may be, for example, 2 mm, 5 mm, 8 mm, 10 mm, 12 mm, 15 mm, 18 mm, 20 mm, 22 mm, 25 mm, 28 mm, 30 mm, 32 mm, or 35 mm, etc.

In the present application, by regulating the length and width of the carbon layer, the carbon material layer can completely adsorb the free fluoride ions; if the length and width are too small, some free fluoride ions will not be adsorbed by the carbon material layer and continue to move to the negative electrode side, thus leading to an increase in the internal resistance of the primary lithium battery during the high-temperature storage; on the other hand, an overly large length or width will cause difficulties for the manufacture of the primary lithium battery, and affect the insulation effect between the positive electrode and the negative electrode.

As an optional technical solution of the present application, a thickness of the carbon layer is 0.02-0.4 mm, which may be, for example, 0.02 mm, 0.04 mm, 0.08 mm, 0.1 mm, 0.12 mm, 0.15 mm, 0.18 mm, 0.2 mm, 0.22 mm, 0.25 mm, 0.28 mm, 0.3 mm, 0.32 mm, 0.35 mm, 0.38 mm, or 0.4 mm, etc.

In the present application, by regulating the thickness of the carbon layer, the carbon material layer can completely adsorb the free fluoride ions; if the thickness is too small, some free fluoride ions will not be adsorbed by the carbon material layer and continue to move to the negative electrode side, thus leading to an increase in the internal resistance of the primary lithium battery during the high-temperature storage; on the other hand, an overly large thickness will reduce the lithium-ion transport rate between the positive electrode and the negative electrode, resulting in an increase in the internal resistance of the primary lithium battery.

As an optional technical solution of the present application, the carbon layer has a length of 8-40 mm and a width of 5-28 mm.

As an optional technical solution of the present application, the carbon layer has a thickness of 0.04-0.3 mm.

As an optional technical solution of the present application, a length of the substrate layer is 7-50 mm, which may be, for example, 7 mm, 8 mm, 10 mm, 12 mm, 15 mm, 18 mm, 20 mm, 22 mm, 25 mm, 28 mm, 30 mm, 32 mm, 35 mm, 38 mm, 40 mm, 42 mm, 45 mm, 48 mm, or 50 mm, etc.; a width of the substrate layer is 4-40 mm, which may be, for example, 4 mm, 5 mm, 8 mm, 10 mm, 12 mm, 15 mm, 18 mm, 20 mm, 22 mm, 25 mm, 28 mm, 30 mm, 32 mm, 35 mm, 38 mm, or 40 mm, etc.

As an optional technical solution of the present application, a thickness of the substrate layer is 0.001-0.3 mm, which may be, for example, 0.001 mm, 0.005 mm, 0.008 mm, 0.01 mm, 0.05 mm, 0.08 mm, 0.1 mm, 0.12 mm, 0.15 mm, 0.18 mm, 0.2 mm, 0.22 mm, 0.25 mm, 0.28 mm, or 0.3 mm, etc.

As an optional technical solution of the present application, the substrate layer has a length of 10-42 mm and a width of 7-30 mm.

As an optional technical solution of the present application, the substrate layer has a thickness of 0.001-0.2 mm.

As an optional technical solution of the present application, a material of the substrate layer is a fiber material; the fiber material exemplarily comprises any one of or a combination of at least two of nonwoven fabric, polyolefin fibers, polyphenylene sulfide fibers, polyester resin fibers (e.g., polybutylene terephthalate fibers, etc.), polyamide resin fibers (e.g., aromatic polyamide resin fibers, etc.), polyimide fibers, polyimide resin fibers (e.g., polyamide-imide fibers, etc.), or polyetheretherketone fibers.

As an optional technical solution of the present application, an area of the carbon layer is 60%-100% of a total area of a single side of the positive electrode or the separator, which may be, for example, 60%, 65%, 70%, 75%, 80%, 85%, 90%, 95%, or 100%, etc.

As an optional technical solution of the present application, an area of the carbon layer is 80%-100% of a total area of a single side of the positive electrode or the separator, which may be, for example, 80%, 85%, 90%, 95%, or 100%, etc.

In the present application, by regulating the area size of the carbon layer, the carbon material layer can completely adsorb the free fluoride ions; if the area is too small, some free fluoride ions will not be adsorbed by the carbon material layer and continue to move to the negative electrode side, thus leading to an increase in the internal resistance of the primary lithium battery during the high-temperature storage; on the other hand, an overly large area will cause difficulties for the manufacture of the primary lithium battery, and affect the insulation effect between the positive electrode and the negative electrode.

As an optional technical solution of the present application, a length of the positive electrode is 8-36 mm, which may be, for example, 8 mm, 10 mm, 12 mm, 15 mm, 18 mm, 20 mm, 22 mm, 25 mm, 28 mm, 30 mm, 32 mm, or 36 mm, etc.; a width of the positive electrode is 5-23 mm, which may be, for example, 5 mm, 8 mm, 10 mm, 12 mm, 15 mm, 18 mm, 20 mm, or 23 mm, etc.

In the present application, in a case where the modified layer is arranged on at least one side of the positive electrode, the carbon layer has a length of 5-40 mm and a width of 2-25 mm.

As an optional technical solution of the present application, a length of the separator is 8-40 mm, which may be, for example, 8 mm, 10 mm, 12 mm, 15 mm, 18 mm, 20 mm, 22 mm, 25 mm, 28 mm, 30 mm, 32 mm, 36 mm, 38 mm, or 40 mm, etc.; a width of the separator is 5-30 mm, which may be, for example, 5 mm, 8 mm, 10 mm, 12 mm, 15 mm, 18 mm, 20 mm, 25 mm, 28 mm, or 30 mm, etc.

In the present application, in a case where the modified layer is arranged on at least one side of the separator, the carbon layer has a length of 5-45 mm and a width of 2-35 mm.

As an optional technical solution of the present application, the primary lithium battery further comprises a cover plate and a positive electrode pole and a liquid injection port which are arranged on the cover plate, the cover plate is also provided with a through-hole, the positive electrode pole passes through the through-hole, and is connected to the positive electrode by a first mesh collector, and a material of the first mesh collector is an aluminum mesh collector.

As an optional technical solution of the present application, two negative electrodes are provided, and the two negative electrodes are arranged opposite to each other on two sides of the positive electrode.

As an optional technical solution of the present application, the primary lithium battery further comprises a second mesh collector, the second mesh collector is connected to the two negative electrodes, and a material of the second mesh collector is a copper mesh collector.

In the present application, the primary lithium battery may be prepared with a conventional preparation method by a person skilled in the art according to the actual situation.

In the present application, the modified layer may be prepared with a conventional preparation method by a person skilled in the art according to the actual situation.

It should be understood that, in the description of the present application, the orientation or position relationship indicated by the terms, such as “center”, “longitudinal”, “lateral”, “up”, “down”, “front”, “back”, “left”, “right”, “vertical”, “horizontal”, “top”, “bottom”, “inside”, “outside”, etc., is based on the orientation or position relationship shown in the drawings, which is only intended to facilitate the description of the present application and to simplify the description, rather than indicating or implying that the device or element referred to must have a particular orientation or must be constructed and operated in a specific orientation, and therefore cannot be understood as a limitation to the present application. In the description of the present application, unless specified otherwise, “a plurality of” means two or more.

It should be noted that, in the description of the present application, unless otherwise specified or defined, the terms “arrangement”, “connection” and “attachment” are to be understood in a broad sense, for example, as a fixed connection, or as a detachable connection, or as an integrated connection; as a mechanical connection, or as an electrical connection; as a direct connection, or as an indirect connection via an intermediate medium, or as a communication between two elements. For those skilled in the field, the specific meaning of the above terms can be understood in the light of specific cases in the present application.

The technical solutions of the present application are further explained with reference to the accompanying drawings and embodiments.

### Example 1

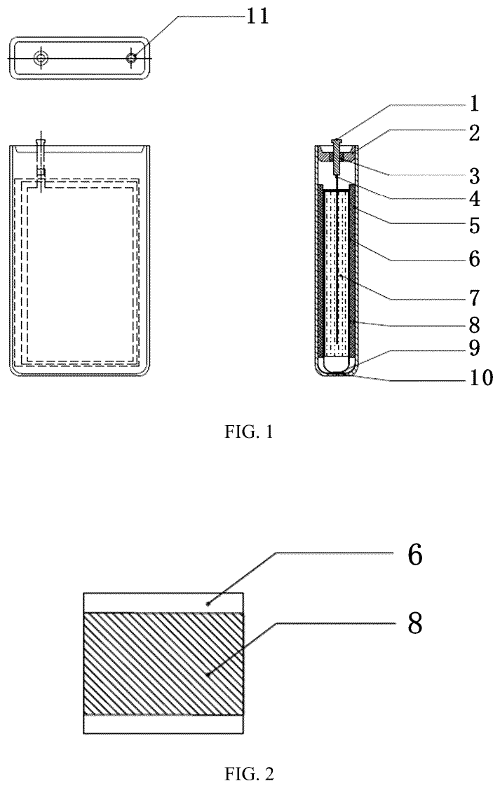

This example provides a primary lithium battery, as shown in FIG. 1. The primary lithium battery comprises a graphite fluoride positive electrode 7, two lithium metal negative electrodes 5, a polyethylene separator 6 arranged between the graphite fluoride positive electrode 7 and the lithium metal negative electrode 5, and a non-aqueous electrolyte, wherein the two lithium metal negative electrodes 5 are arranged opposite to each other on two sides of the graphite fluoride positive electrode 7; as shown in FIG. 2, a modified layer 8 is arranged on a side of the polyethylene separator 6 facing the graphite fluoride positive electrode 7; the modified layer 8 comprises a polyimide substrate layer and a carbon layer arranged on one side of the polyimide substrate layer. The polyimide substrate layer is in contact with a surface of the polyethylene separator 6, and the carbon layer is arranged on a side of the polyethylene separator 6 facing the graphite fluoride positive electrode 7. The primary lithium battery further comprises a cover plate 2 and a liquid injection port 11 which is arranged on the cover plate 2, and a through-hole is arranged on the cover plate 2, a glass seal 3 is filled in the through-hole, a positive electrode pole 1 passes through the through-hole and is connected with the graphite fluoride positive electrode 7 by a positive mesh collector 4, and the two lithium metal negative electrodes 5 are connected with each other by a negative mesh collector 9. The negative mesh collector 9 is connected to the bottom of a steel shell by welding, and a bottom film 10 is arranged above the welding position of the negative mesh collector 9.

The carbon layer has a length of 24 mm, a width of 21 mm, and a thickness of 0.2 mm; an area of the carbon layer is 100% of the total area of single side of the polyethylene separator 6. The polyimide substrate layer has a length of 26 mm, a width of 22 mm, and a thickness of 0.1 mm.

The graphite fluoride positive electrode 7 has a length of 22.5 mm and a width of 20 mm; the polyethylene separator 6 has a length of 24 mm and a width of 21 mm.

The composition of the non-aqueous electrolyte comprises lithium tetrafluoroborate with a concentration of 1 mol/L and a mixed solvent, and the mixed solvent is prepared by mixing propylene carbonate (PC) and 1,2-dimethoxyethane (DME) in a volume ratio of 1:1.

This example also provides a preparation method for the above primary lithium battery, and the preparation method comprises the following steps:
a slurry containing graphite, a polyvinylidene fluoride binder, a carboxymethyl cellulose thickener, and a methanol dispersant was blade-coated on one side of the polyimide substrate layer, dried at 120° C., and then cut to obtain the modified layer;
the modified layer was roller-pressed on one side of the polyethylene separator for compounding, and the carbon layer was arranged on the side of the polyethylene separator facing the graphite fluoride positive electrode; a primary product was obtained; and then the primary product, the lithium metal negative electrode, the polyethylene separator, and the non-aqueous electrolyte were assembled to obtain the primary lithium battery.

### Example 2

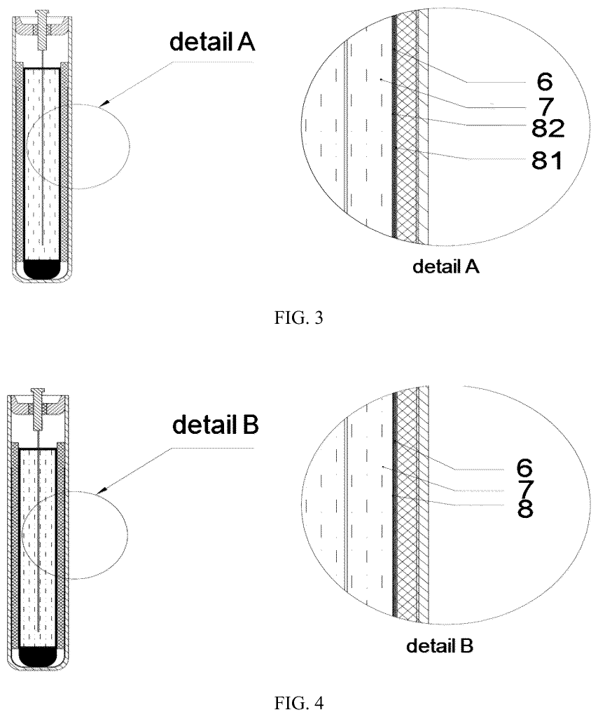

This example provides a primary lithium battery; the primary lithium battery comprises a graphite fluoride positive electrode 7, two lithium metal negative electrodes 5, a polyethylene separator 6 arranged between the graphite fluoride positive electrode 7 and the lithium metal negative electrode 5, and a non-aqueous electrolyte, wherein the two lithium metal negative electrodes 5 are arranged opposite to each other on two sides of the graphite fluoride positive electrode 7; as shown in FIG. 3, a first modified layer 81 is arranged on the side of the polyethylene separator 6 facing the lithium metal negative electrode 5, and a second modified layer 82 is arranged on the side of the graphite fluoride positive electrode 7 facing the polyethylene separator 6; the first modified layer 81 comprises a first polyimide substrate layer and a first carbon layer arranged on one side of the first polyimide substrate layer, and the second modified layer 82 comprises a second polyimide substrate layer and a second carbon layer arranged on one side of the second polyimide substrate layer. The first polyimide substrate layer is in contact with a surface of the polyethylene separator 6, the first carbon layer is arranged on the side of the polyethylene separator 6 facing the lithium metal negative electrode 5, and the second polyimide substrate layer is arranged on the surface of the graphite fluoride positive electrode 7, and the second carbon layer is arranged on a side of the graphite fluoride positive electrode 7 facing the polyethylene separator 6. The primary lithium battery further comprises a cover plate 2 and a liquid injection port 11 which is arranged on the cover plate 2, and a through-hole is arranged on the cover plate 2, a glass seal 3 is filled in the through-hole, a positive electrode pole 1 passes through the through-hole and is connected with the graphite fluoride positive electrode 7 by the positive mesh collector 4, and the two lithium metal negative electrodes 5 are connected with each other by a negative mesh collector 9. The negative mesh collector 9 is connected to the bottom of a steel shell by welding, and a bottom film 10 is arranged above the welding position of the negative mesh collector 9.

The first carbon layer arranged on the polyethylene separator 6 has a length of 20 mm, a width of 15 mm, and a thickness of 0.1 mm; an area of the first carbon layer is 80% of the total area of a single side of the polyethylene separator 6. The first polyimide substrate layer has a length of 22 mm, a width of 15 mm, and a thickness of 0.05 mm. The second carbon layer arranged on the graphite fluoride positive electrode 7 has a length of 20 mm, a width of 12 mm, and a thickness of 0.1 mm; and an area of the second carbon layer is 80% of the total area of a single side of the graphite fluoride positive electrode 7. The second polyimide substrate layer has a length of 20 mm, a width of 12 mm, and a thickness of 0.05 mm.

The graphite fluoride positive electrode 7 has a length of 20 mm and a width of 15 mm; the polyethylene separator 6 has a length of 22 mm and a width of 17 mm.

The composition of the non-aqueous electrolyte comprises lithium tetrafluoroborate with a concentration of 1 mol/L and a mixed solvent, and the mixed solvent is prepared by mixing propylene carbonate (PC) and 1,2-dimethoxyethane (DME) in a volume ratio of 1:1.

This example also provides a preparation method for the above primary lithium battery, and the preparation method comprises the following steps:
a slurry containing graphite, a polyvinylidene fluoride binder, a carboxymethyl cellulose thickener, and a methanol dispersant was blade-coated on one side of the polyimide substrate layer, dried at 120° C., and then cut to obtain the modified layer;
the first modified layer was roller-pressed on one side of the polyethylene separator for compounding, and the first carbon layer was arranged on the side of the polyethylene separator facing the lithium metal negative electrode, and the second modified layer was roller-pressed on one side of the graphite fluoride positive electrode for compounding, and the second carbon layer was arranged on the side of the graphite fluoride positive electrode facing the polyethylene separator; a primary product was obtained; and then the primary product, the lithium metal negative electrode, the polyethylene separator, and the non-aqueous electrolyte were assembled to obtain the primary lithium battery.

### Example 3

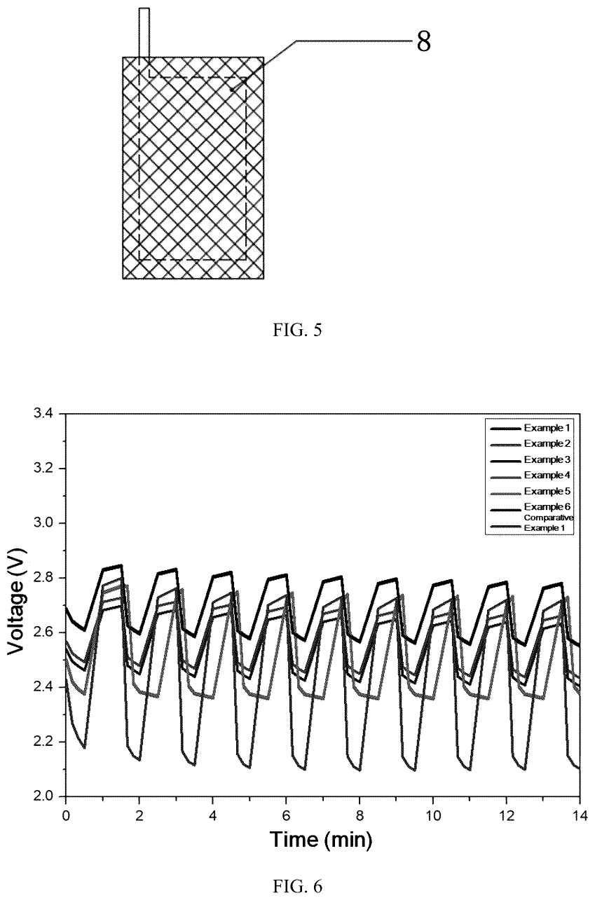

This example provides a primary lithium battery; the primary lithium battery comprises a graphite fluoride positive electrode 7, two lithium metal negative electrodes 5, a polyethylene separator 6 arranged between the graphite fluoride positive electrode 7 and the lithium metal negative electrode 5, and a non-aqueous electrolyte, wherein the two lithium metal negative electrodes 5 are arranged opposite to each other on two sides of the graphite fluoride positive electrode 7; as shown in FIGS. 4-5, a modified layer 8 is arranged on the side of the graphite fluoride positive electrode 7 facing the polyethylene separator 6; the modified layer 8 comprises a polyimide substrate layer and a carbon layer arranged on one side of the polyimide substrate layer. The polyimide substrate layer is arranged on a surface of the graphite fluoride positive electrode 7, and the carbon layer is arranged on the side of the graphite fluoride positive electrode 7 facing the polyethylene separator 6. The primary lithium battery further comprises a cover plate 2 and a liquid injection port 11 arranged on the cover plate 2, and a through-hole is arranged on the cover plate 2, a glass seal 3 is filled in the through-hole, a positive electrode pole 1 passes through the through-hole and is connected with the graphite fluoride positive electrode 7 by the positive mesh collector 4, and the two lithium metal negative electrodes 5 are connected with each other through a negative mesh collector 9. The negative mesh collector 9 is connected to the bottom of a steel shell by welding, and a bottom film 10 is arranged above the welding position of the negative mesh collector 9.

The carbon layer has a length of 20 mm, a width of 12 mm, and a thickness of 0.1 mm; an area of the carbon layer is 80% of the total area of a single side of the graphite fluoride positive electrode 7. The polyimide substrate layer has a length of 22 mm, a width of 12 mm, and a thickness of 0.05 mm.

The graphite fluoride positive electrode 7 has a length of 20 mm and a width of 15 mm; the polyethylene separator 6 has a length of 22 mm and a width of 17 mm.

The composition of the non-aqueous electrolyte comprises lithium tetrafluoroborate with a concentration of 1 mol/L and a mixed solvent, and the mixed solvent is prepared by mixing propylene carbonate (PC) and 1,2-dimethoxyethane (DME) in a volume ratio of 1:1.

This example also provides a preparation method for the above primary lithium battery, and the preparation method comprises the following steps:
a slurry containing graphite, polyvinylidene fluoride binder, a carboxymethyl cellulose thickener, and a methanol dispersant was blade-coated on one side of the polyimide substrate layer, dried at 120° C., and then cut to obtain the modified layer;
the modified layer was roller-pressed on one side of the graphite fluoride for compounding, and the carbon layer was arranged on the side of graphite fluoride positive electrode facing the polyethylene separator; a primary product was obtained; and then the primary product, the lithium metal negative electrode, the polyethylene separator, and the non-aqueous electrolyte were assembled to obtain the primary lithium battery.

### Example 4

This example provides a primary lithium battery; the primary lithium battery comprises a graphite fluoride positive electrode 7, two lithium metal negative electrodes 5, a polyethylene separator 6 arranged between the graphite fluoride positive electrode 7 and the lithium metal negative electrode 5, and a non-aqueous electrolyte, wherein the two lithium metal negative electrodes 5 are arranged opposite to each other on two sides of the graphite fluoride positive electrode 7; a modified layer 8 is arranged on the side of the graphite fluoride positive electrode 7 facing the polyethylene separator 6; the modified layer 8 comprises a polyimide substrate layer and a carbon layer which is arranged on one side of the polyimide substrate layer. The polyimide substrate layer is arranged on a surface of the graphite fluoride positive electrode 7, and the carbon layer is arranged on the side of the graphite fluoride positive electrode 7 facing the polyethylene separator 6. The primary lithium battery further comprises a cover plate 2 and a liquid injection port 11 arranged on the cover plate 2, and a through-hole is arranged on the cover plate 2, a glass seal 3 is filled in the through-hole, a positive electrode pole 1 passes through the through-hole and is connected with the graphite fluoride positive electrode 7 by the positive mesh collector 4, and the two lithium metal negative electrodes 5 are connected with each other through a negative mesh collector 9. The negative mesh collector 9 is connected to the bottom of a steel shell by welding, and a bottom film 10 is arranged above the welding position of the negative mesh collector 9.

The carbon layer has a length of 15 mm, a width of 10 mm, and a thickness of 0.25 mm; an area of the carbon layer is 100% of the total area of a single side of the graphite fluoride positive electrode 7. The polyimide substrate layer has a length of 30 mm, a width of 22 mm, and a thickness of 0.15 mm.

The graphite fluoride positive electrode 7 has a length of 15 mm and a width of 10 mm; the polyethylene separator 6 has a length of 17 mm and a width of 12 mm.

The composition of the non-aqueous electrolyte comprises lithium tetrafluoroborate with a concentration of 1 mol/L and a mixed solvent, and the mixed solvent is prepared by mixing propylene carbonate (PC) and 1,2-dimethoxyethane (DME) in a volume ratio of 1:1.

This example also provides a preparation method for the above primary lithium battery, and the preparation method comprises the following steps:
a slurry containing graphite, a polyvinylidene fluoride binder, a carboxymethyl cellulose thickener, and a methanol dispersant was blade-coated on one side of the polyimide substrate layer, dried at 120° C., and then cut to obtain the modified layer;
the modified layer was roller-pressed on one side of the graphite fluoride positive electrode for compounding, and the carbon layer was arranged on the side of graphite fluoride positive electrode facing the polyethylene separator; a primary product was obtained; and then the primary product, the lithium metal negative electrode, the polyethylene separator, and the non-aqueous electrolyte were assembled to obtain the primary lithium battery.

### Example 5

This example provides a primary lithium battery; the primary lithium battery comprises a graphite fluoride positive electrode 7, two lithium metal negative electrodes 5, a polyethylene separator 6 arranged between the graphite fluoride positive electrode 7 and the lithium metal negative electrode 5, and a non-aqueous electrolyte, wherein the two lithium metal negative electrodes 5 are arranged opposite to each other on two sides of the graphite fluoride positive electrode 7; a modified layer 8 is arranged on the side of the graphite fluoride positive electrode 7 facing the polyethylene separator 6; the modified layer 8 comprises a polyimide substrate layer and a carbon layer arranged on one side of the polyimide substrate layer. The polyimide substrate layer is arranged on a surface of the graphite fluoride positive electrode 7, and the carbon layer is arranged on the side of the graphite fluoride positive electrode 7 facing the polyethylene separator 6. The primary lithium battery further comprises a cover plate 2 and a liquid injection port 11 arranged on the cover plate 2, and a through-hole is arranged on the cover plate 2, a glass seal 3 is filled in the through-hole, a positive electrode pole 1 passes through the through-hole and is connected with the graphite fluoride positive electrode 7 by the positive mesh collector 4, and the two lithium metal negative electrodes 5 are connected with each other through a negative mesh collector 9. The negative mesh collector 9 is connected to the bottom of a steel shell by welding, and a bottom film 10 is arranged above the welding position of the negative mesh collector 9.

The carbon layer has a length of 6 mm, a width of 4 mm, and a thickness of 0.04 mm; an area of the carbon layer is 60% of the total area of a single side of the graphite fluoride positive electrode 7. The polyimide substrate layer has a length of 7 mm, a width of 4 mm, and a thickness of 0.005 mm.

The graphite fluoride positive electrode 7 has a length of 8 mm and a width of 5 mm; the polyethylene separator 6 has a length of 10 mm and a width of 7 mm.

The composition of the non-aqueous electrolyte comprises lithium tetrafluoroborate with a concentration of 1 mol/L and a mixed solvent, and the mixed solvent is prepared by mixing propylene carbonate (PC) and 1,2-dimethoxyethane (DME) in a volume ratio of 1:1.

This example also provides a preparation method for the above primary lithium battery, and the preparation method comprises the following steps:
a slurry containing graphite, polyvinylidene fluoride binder, a carboxymethyl cellulose thickener, and a methanol dispersant was blade-coated on one side of the polyimide substrate layer, dried at 120° C., and then cut to obtain the modified layer;
the modified layer was roller-pressed on one side of the graphite fluoride positive electrode for compounding, and the carbon layer was arranged on the side of graphite fluoride positive electrode facing the polyethylene separator; a primary product was obtained; and then the primary product, the lithium metal negative electrode, the polyethylene separator, and the non-aqueous electrolyte were assembled to obtain the primary lithium battery.

### Example 6

This example provides a primary lithium battery; the primary lithium battery comprises a graphite fluoride positive electrode 7, two lithium metal negative electrodes 5, a polyethylene separator 6 arranged between the graphite fluoride positive electrode 7 and the lithium metal negative electrode 5, and a non-aqueous electrolyte, wherein the two lithium metal negative electrodes 5 are arranged opposite to each other on two sides of the graphite fluoride positive electrode 7; a modified layer 8 is arranged on the side of the graphite fluoride positive electrode 7 facing the polyethylene separator 6; the modified layer 8 comprises a polyimide substrate layer and a carbon layer which is arranged on one side of the polyimide substrate layer. The polyimide substrate layer is arranged on the surface of the graphite fluoride positive electrode 7, and the carbon layer is arranged on the side of the graphite fluoride positive electrode 7 facing the polyethylene separator 6. The primary lithium battery further comprises a cover plate 2 and a liquid injection port 11 arranged on the cover plate 2, and a through-hole is arranged on the cover plate 2, a glass seal 3 is filled in the through-hole, a positive electrode pole 1 passes through the through-hole and is connected with the graphite fluoride positive electrode 7 by the positive mesh collector 4, and the two lithium metal negative electrodes 5 are connected with each other through a negative mesh collector 9. The negative mesh collector 9 is connected to the bottom of a steel shell by welding, and a bottom film 10 is arranged above the welding position of the negative mesh collector 9.

The carbon layer has a length of 36 mm, a width of 23 mm, and a thickness of 0.4 mm; an area of the carbon layer is 100% of the total area of a single side of the graphite fluoride positive electrode 7. The polyimide substrate layer has a length of 50 mm, a width of 40 mm, and a thickness of 0.3 mm.

The graphite fluoride positive electrode 7 has a length of 36 mm and a width of 23 mm; the polyethylene separator 6 has a length of 40 mm and a width of 30 mm.

The composition of the non-aqueous electrolyte comprises lithium tetrafluoroborate with a concentration of 1 mol/L and a mixed solvent, and the mixed solvent is prepared by mixing propylene carbonate (PC) and 1,2-dimethoxyethane (DME) in a volume ratio of 1:1.

This example also provides a preparation method for the above primary lithium battery, and the preparation method comprises the following steps:
a slurry containing graphite, a polyvinylidene fluoride binder, a carboxymethyl cellulose thickener, and a methanol dispersant was blade-coated on one side of the polyimide substrate layer, dried at 120° C., and then cut to obtain the modified layer;
the modified layer was roller-pressed on one side of the graphite fluoride positive electrode for compounding, and the carbon layer was arranged on one side of graphite fluoride positive electrode facing the polyethylene separator; a primary product was obtained; and then the primary product, the lithium metal negative electrode, the polyethylene separator, and the non-aqueous electrolyte were assembled to obtain the primary lithium battery.

### Comparative Example 1

This comparative example differs from Example 1 in that no modified layer was provided, and the rest was the same as that of Example 1.

### Test Condition

The primary lithium batteries provided in Example 1-6 and Comparative Example 1 were tested, and the test method is as follows:

after discharged at a current of 10 mA by 90% of discharge depth, the battery was stored at a high temperature of 60° C. for 1 week, the internal resistance and voltage of the lithium primary battery before and after storage was tested, and the pulse performance of the lithium primary battery at a high temperature of 45° C. was tested after the lithium primary battery was stored at a high temperature of 60° C., and the specific test method is: discharging according to the following pulse pattern: constant-current discharging with a current of 10 mA for 30 s, and standing for 1 min.

The test results are shown in Table 1:

TABLE 1

| | | Internal | | Internal |
|---|---|---|---|---|
| | Voltage | resistance | Voltage | resistance |
| | before | before | after | after |
| | storage | storage | storage | storage |
| | (V) | (Ω) | (V) | (Ω) |
| Example 1 | 2.910 | 7.54 | 3.255 | 14.15 |
| Example 2 | 2.926 | 8.33 | 3.231 | 13.36 |
| Example 3 | 2.935 | 10.36 | 3.250 | 27.38 |
| Example 4 | 2.921 | 9.49 | 3.245 | 28.97 |
| Example 5 | 2.914 | 8.43 | 3.248 | 47.48 |
| Example 6 | 2.932 | 11.21 | 3.249 | 49.02 |
| Comparative | 2.914 | 11.78 | 3.247 | 126.22 |
| Example 1 | | | | |

As can be seen from Table 1, compared to Comparative Example 1, the primary lithium batteries provided in Examples 1-6 in the present application have the modified layer arranged on at least one side of the positive electrode and/or the separator, and thereby protect the surface of the negative electrode from the manganese dioxide or graphite fluoride positive active substance, and ultimately, the dissolved manganese ions or fluoride ions are prevented from reacting with the negative electrode to form a high-resistance coating, thereby reducing the internal resistance of the primary lithium battery and enhancing the pulse performance at high temperature of the primary lithium battery.

As can be seen from FIG. 6, the primary lithium battery provided in the present application has good pulse discharge performance at high temperature.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A primary lithium battery, comprising:
a positive electrode, a negative electrode, a separator arranged between the positive electrode and the negative electrode, and a non-aqueous electrolyte;
a modified layer arranged on at least one side of the positive electrode facing the negative electrode, or at least one side of the separator, or at least one side of the positive electrode facing the negative electrode and at least one side of the separator;
wherein the modified layer includes a substrate layer and a carbon layer which is arranged on one side of the substrate layer.

2. The primary lithium battery according to claim 1, wherein in a case where the modified layer is arranged on at least one side of the positive electrode, the substrate layer is in contact with at least one surface of the positive electrode, and the carbon layer is arranged on a side of the positive electrode facing the separator; and
in a case where the modified layer is arranged on at least one side of the separator, the substrate layer is in contact with at least one surface of the separator, and the carbon layer is arranged on a side of the separator facing the positive electrode, a side of the separator facing the negative electrode, or two sides of the separator.

3. The primary lithium battery according to claim 1, wherein the carbon layer has a length of 5-45 mm and a width of 2-35 mm; and the carbon layer has a thickness of 0.02-0.4 mm.

4. The primary lithium battery according to claim 3, wherein the carbon layer has a length of 8-40 mm and a width of 5-28 mm; and the carbon layer has a thickness of 0.04-0.3 mm.

5. The primary lithium battery according to claim 1, wherein the substrate layer has a length of 7-50 mm and a width of 4-40 mm; and the substrate layer has a thickness of 0.001-0.3 mm;
wherein a material of the substrate layer is a fiber material.

6. The primary lithium battery according to claim 5, wherein the substrate layer has a length of 10-42 mm and a width of 7-30 mm; and the substrate layer has a thickness of 0.001-0.2 mm.

7. The primary lithium battery according to claim 1, wherein an area of the carbon layer is 60%-100% of a total area of a single side of the positive electrode or the separator.

8. The primary lithium battery according to claim 1, wherein an area of the carbon layer is 80%-100% of a total area of a single side of the positive electrode or the separator.

9. The primary lithium battery according to claim 1, wherein the positive electrode has a length of 8-36 mm and a width of 5-23 mm.

10. The primary lithium battery according to claim 1, wherein the separator has a length of 8-40 mm and a width of 5-30 mm.

11. The primary lithium battery according to claim 1, wherein the primary lithium battery further comprises a cover plate and a positive electrode pole and a liquid injection port which are arranged on the cover plate, the cover plate is also provided with a through-hole, the positive electrode pole passes through the through-hole and is connected to the positive electrode by a first mesh collector.

12. The primary lithium battery according to claim 1, wherein two negative electrodes are provided, and the two negative electrodes are arranged opposite to each other on two sides of the positive electrodes; and the primary lithium battery further comprises a second mesh collector, wherein the second mesh collector connects the two negative electrodes.

13. The primary lithium battery according to claim 2, wherein the carbon layer has a length of 5-45 mm and a width of 2-35 mm; and the carbon layer has a thickness of 0.02-0.4 mm.
